(19) United States
(12) Patent Application Publication
(10) Pub. No.: US 2014/0280095 A1
(43) Pub. Date: Sep. 18, 2014

(54) SYSTEMS, METHODS AND APPARATUS FOR RATING AND FILTERING ONLINE CONTENT

(71) Applicants: Gregory Friedman, Los Angeles, CA (US); Deven Scott Nemer, Thousand Oaks, CA (US)

(72) Inventors: Gregory Friedman, Los Angeles, CA (US); Deven Scott Nemer, Thousand Oaks, CA (US)

(73) Assignee: NEVADA FUNDING GROUP INC., Las Vegas, NV (US)

(21) Appl. No.: 14/206,097

(22) Filed: Mar. 12, 2014

Related U.S. Application Data
(60) Provisional application No. 61/792,750, filed on Mar. 15, 2013.

(51) Int. Cl. G06F 17/30

(52) U.S. Cl. CPC G06F 17/3053
USPC 707/723; 707/748

(57) ABSTRACT

A plurality of ratings associated with content accessible at a network address is received from a plurality of users, wherein each of the ratings corresponds to one of a plurality of content attributes. A combined set of ratings is generated fix the content based on the plurality of ratings, wherein the combined set of ratings comprises, for each of the plurality of content attributes, a combined rating value. A plurality of criteria is received from a user device, wherein each criterion corresponds to a respective one among a plurality of content attributes. A request to access the content is received from the user device. The combined set of ratings is compared to the plurality of criteria received from the user device. The user device is allowed to access the content if the combined set of ratings does not conflict with the plurality of criteria. The user device is prevented from accessing the content if the combined set of ratings conflicts with the plurality of criteria.

This application claims priority from U.S. Provisional Application No. 61/792,750, filed Mar. 15, 2013, which is hereby incorporated by reference herein in its entirety.

### TECHNICAL FIELD

This specification relates generally to systems and methods for managing online content, and more particularly to systems and methods for rating and filtering online content.

### BACKGROUND

A large and continually increasing supply of content of all types is available via the Internet. Many users have a need to filter the available content, for a variety of purposes. For example, some users wish to prevent children from accessing certain types of content. Other users have a need to filter content efficiently in order to identify content of a desired nature. Some users wish to take the behavior of other users into account in filtering content. Accordingly, there is an ongoing need for improved systems and methods capable of filtering online content in a manner that achieves the objectives of each individual user.

### SUMMARY

In accordance with an embodiment, a method of filtering content is provided. A plurality of ratings associated with content accessible at a network address is received from a plurality of users, wherein each of the ratings corresponds to one of a plurality of content attributes. A combined set of ratings is generated for the content based on the plurality of ratings, wherein the combined set of ratings comprises, for each of the plurality of content attributes, a combined rating value. A plurality of criteria is received from a user device, wherein each criterion corresponds to a respective one among a plurality of content attributes. A request to access the content is received from the user device. The combined set of ratings is compared to the plurality of criteria received from the user device. The user device is allowed to access the content if the combined set of ratings does not conflict with the plurality of criteria. The user device is prevented from accessing the content if the combined set of ratings conflicts with the plurality of criteria.

In one embodiment, a second user device employed by one of the plurality of users is caused to display a rate content option. A selection of the rate content option is received, and, in response to the selection, the one user is prompted to provide one or more ratings associated with the content.

In another embodiment, generating the combined set of ratings further comprises determining, for each of the plurality of users, a respective trust score, adjusting the plurality of ratings based on one or more trust scores, generating a weighted set of ratings, and generating, for each of the plurality of content attributes, a weighted average rating based on the weighted set of ratings.

In another embodiment, adjusting the plurality of ratings further comprises increasing a rating value provided by a particular user when a trust score of the particular user is determined to be above a predetermined value.

In another embodiment, the plurality of content attributes comprise a learn attribute, an inspire attribute, a fun attribute, and an ethics attribute. The plurality of content attributes may further comprise one of a religion attribute and a political viewpoint attribute.

In accordance with another embodiment, a method of providing information is provided. A plurality of search results is obtained based on a request from a first user of a communication network, each search result being associated with content accessible via the communication network. A first plurality of criteria associated with the first user is obtained, wherein each of the first plurality of criteria corresponds to a respective one among a plurality of content attributes. A plurality of second users of the communication network are identified, each second user having a second plurality of criteria that has a predetermined degree of similarity to the first plurality of criteria. For each second user among the plurality of second users, a trust score earned by the respective second user based on activities conducted within the communication network is determined. For each search result among the plurality of search results, a series of first operations is performed, the first operations comprising: for each second user among the plurality of second users, a series of second operations is performed, the second operations comprising determining a frequency value indicating how often the respective second user views the respective search result, determining at least one rating value indicating a rating produced by the respective second user with respect to an attribute of the content associated with the respective search result, weighting the frequency value based on the trust score of the respective second user, generating a weighted frequency value, and weighting the rating value based on the trust score of the respective second user, generating a weighted rating value. At least one combined weighted frequency value and a set of combined weighted rating values are generated for each respective search result among the plurality of search results. Respective priority values are determined for the plurality of search results, based on the combined weighted frequency value(s), the set of combined weighted rating values, and the first plurality of criteria. The plurality of search results are provided to the first user arranged in an order determined based on the priority values.

In one embodiment, a determination is made that a second user has a second plurality of criteria that has a predetermined degree of similarity to the first plurality of criteria when a first predetermined number of the first plurality of criteria differ from corresponding ones of the second plurality of criteria by less than a second predetermined number.

In another embodiment, the plurality of content attributes comprise a learn attribute, an inspire attribute, a fun attribute, and an ethics attribute. The plurality of content attributes may further comprise one of a religion attribute and a political viewpoint attribute.

In another embodiment, one or more combined weighted average frequency values are generated by averaging the weighted frequency values. The set of combined weighted rating values is generated by averaging the weighted rating values.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a communication system in accordance with an embodiment

FIG. 2 shows components of a network manager in accordance with an embodiment;

FIG. 3 shows components of a user worldview service in accordance with an embodiment;

FIG. 4 shows components of a ratings service in accordance with an embodiment;

FIG. 5 shows components of a content manager in accordance with an embodiment;

FIG. 6 shows components of a search service in accordance with an embodiment;

FIG. 7 shows an exemplary user login page in accordance with an embodiment;

FIG. 8 shows an exemplary menu page in accordance with an embodiment;

FIG. 9A shows a web page in accordance with an embodiment;

FIG. 9B shows a query box displayed over a web page in accordance with an embodiment;

FIG. 9C shows a ratings box displayed over a web page in accordance with an embodiment;

FIG. 9D shows a worldview factors box displayed over a web page in accordance with an embodiment;

FIG. 9E shows a second ratings box displayed over a web page in accordance with an embodiment;

FIG. 10 shows a web page in accordance with an embodiment;

FIG. 11 shows a combined content ratings database in accordance with an embodiment;

FIG. 12 shows a user trust score database in accordance with an embodiment;

FIG. 13 shows a combined content ratings database in accordance with another embodiment;

FIG. 14 shows a filtering criteria page in accordance with an embodiment;

FIG. 13 shows user a worldview database in accordance with an embodiment;

FIG. 16 is a flowchart of a method of filtering content in accordance with an embodiment;

FIG. 17 shows a message displayed above a web page in accordance with an embodiment;

FIGS. 18A-18C comprise a flowchart of a method of prioritizing search results in accordance with an embodiment;

FIG. 19 shows a search page in accordance with an embodiment;

FIG. 20 shows a plurality of search results in accordance with an embodiment;

FIG. 21 shows the plurality of search results of the embodiment of FIG. 20 after one or more results have been removed, in accordance with an embodiment;

FIG. 22 shows a similar user trust score file in accordance with an embodiment;

FIG. 23 shows a similar users behavior file ill accordance with an embodiment;

FIG. 24 shows a similar Users ratings file in accordance with an embodiment;

FIG. 25 shows the plurality of search results of the embodiment of FIG. 21 after being reordered, in accordance with an embodiment;

FIG. 26 shows a search results page in accordance with an embodiment; and

FIG. 27 is a high-level block diagram of an exemplary computer that may be used to implement certain embodiments.

### DETAILED DESCRIPTION

In accordance with an embodiment, content and services are provided to users via a communication system. Each user who accesses and views content provides one or more ratings of the content, wherein each respective rating corresponds to a particular content attribute. For each item of content, ratings from multiple users are combined to generate a combined set of ratings for the content. Separately, a particular user may define a set of criteria corresponding to various content attributes, based on the user's preferences and worldview. A particular item of content is filtered for the particular user based on the user-defined criteria and the combined set of ratings associated with the content.

FIG. 1 shows a communication system in accordance with an embodiment. Communication system 100 comprises a network 105, a network manager 135, a user worldview service 120, a ratings service 130, a content manager 140, and a search service 150. Communication system 100 also includes a plurality of content servers 170-A, 170-B, 170-C, etc. Communication system 100 also comprises a plurality of user devices 160-A, 160-B, 160-C, etc.

For convenience, the term “content server 170” is sometimes used herein to refer to any one of content servers 170-A, 170-B, 170-C, etc. Accordingly, any discussion herein referring to “content server 170” is equally applicable to each of content servers 170-A, 170-B, 170-C, etc. Communication system 100 may include more or fewer than three content servers,

Similarly, the term “user device 160” is sometimes used herein to refer to any one of user devices 160-A, 160-B, 160-C, etc. Accordingly, any discussion herein referring to “user device 160” is equally applicable to each of user devices 160-A, 160-B, 160-C, etc. Communication system 100 may include more or fewer than three user devices.

In the exemplary embodiment of FIG. 1, network 105 is the Internet. In other embodiments, network 105 may comprise one or more of a number of different types of networks, such as, for example, an Intranet, a local area network (LAN), a wide area network a wireless network, a Fibre Channel-based storage area network (SAN), or Ethernet. Other networks may be used. Alternatively, network 105 may comprise a combination of different types of networks.

Content server 170 stores content that may be accessed via network 105. For example, content stored on a content server may be provided to a user in the form of a web page, or in another format.

User device 160 may be an device that enables a user to communicate via network 105. User device 160 may be connected to network 105 through a direct (wired) link, or wirelessly. In one embodiment, user device 160 has a display screen for displaying information. For example, user device 160 may be a personal computer, a laptop computer, a workstation, a mainframe computer, etc. Alternatively, user device 160 may be a mobile communication device such as a wireless phone, a personal digital assistant, etc. Other devices may be used.

Network manager 135 controls access to content and services. FIG. 2 shows components of network manager 135 in accordance with an embodiment. Network manager 135 includes a controller 210, a user registration & login module 220, and a storage 230. Controller 210 orchestrates the operation of other components of network manager 135. User registration & login module 220 manages the registration and login of a user prior to the user being permitted to access content and services. Storage 230 is used from time to time by other components of network manager 135 to store various types of data. For example, a user registration database 265 containing usernames, passwords, and other information relating to various users is stored in storage 230. Network manager 135 may include other components not shown in FIG. 2.

Network manager 135 collects and stores information about the activities and behavior of various users of communication network 105. For example, information indicating which websites a user visits, how often and when the user visits a web site, which products the user purchases, with whom a user communicates by email, etc., is recorded and stored. Such information is stored in a user behavior database 272 in storage 230, as shown in FIG. 2.

FIG. 3 shows components of user worldview service 120 in accordance with an embodiment. User worldview service 120 comprises a user polling module 310 and a storage 330. User polling module 310 may from time to time receive from a user information relating to the user's preferences, personal values, philosophy, beliefs, priorities, opinions, etc. Such information received from users is stored in a user worldview database 360 within storage 330. User worldview service 120 may include other components not shown in FIG. 3.

FIG. 4 shows components of ratings service 130 in accordance with an embodiment. Ratings service 130 comprises a ratings module 410 and a storage 420. Ratings module 410 from time to time receives from a user one or more ratings of selected content accessible via network 105 e.g., content accessible at an Internet address or at another network location. A user may submit a plurality of ratings, each rating relating to a respective attribute of the content. Ratings received from users are stored in a user ratings database 448 stored within storage 420. In the illustrative embodiment, ratings from multiple users are combined to generate combined ratings for various items of content. For example, averages or weighted averages of ratings from various users may be generated. In other embodiments, ratings from various users may be combined in other was to generate combined ratings. The combined ratings are stored in a combined content ratings database 450 within storage 420. Ratings service 130 may include other components not shown in FIG. 3.

FIG. 5 shows components of content manager 140 in accordance with an embodiment. Content manager 140 comprises a content server 510, a filtering module 520, and a storage 530. Content server 510 from time to time provides content to a user. For example, content server 510 may receive from a user employing a user device 160 a request for content associated with a particular web page which is associated with a particular world wide web address. In response, content manager 140 identifies a content server 170 that stores the requested content, retrieves the content from the content server, and provides the content (e.g., in the form of a web page) to user device 160. Filtering module 520 filters content based on a variety of parameters. Thus, from time to time filtering module 520 may prevent content server 510 from providing a particular item of content to a particular user or user device, based on one or more filtering parameters. Storage 530 is used by other components of content manager 140 to store various types of data. Content manager 140 may include other components not shown in FIG. 5.

FIG. 6 shows components of search service 150 in accordance with an embodiment. Search service 150 comprises a search engine 610, a content prioritization module 620, and a storage 630. Search engine 610 may from time to time perform a search functions (e.g., an Internet search function) based on information, provided by a user. Search engine 610 ma be a publicly available search engine or a proprietary search engine. Content prioritization module 620 examines search results obtained by search engine 610 and prioritizes the search results based on a variety of prioritization parameters. Storage 630 is used from time to time by other components of search service 150 to store various types of data. Search service 150 may include other components not shown in FIG. 6.

In accordance with an embodiment, a user may access content via network 105 and provide one or more ratings of the content. In an illustrative embodiment, suppose that a user employing user device 160-A accesses a website maintained by network manager 135. For example, the user may utilize a browser application (not shown) residing and operating on user device 160-A to access the website. Upon accessing the website, user registration & login module 220 (of network manager 135) may provide a user login page such as that shown in FIG. 7. User login page 700 includes a username field 710 and a password field 720. After the user enters a valid username and password, and is authenticated, controller 210 (of network manager 135) causes the browser on user device 160-A to display a menu page such as that shown in FIG. 8 that indicates one or more products and/or services available via the website. Menu page 800 presents a plurality of selections including a search button 810, a games button 820, a chat button 830, a store button 840, a music button 850, and an email button 860. Other selections may be included.

While in the illustrative embodiment, components of communication system 100 from time to time provide web pages which a user may view and employ to enter information, in other embodiments, other interfaces may be used to communicate with a user. For example, in another embodiment, one or more pages associated with a mobile App may be used.

Supposing that the user wishes to view content available via network 105, the user specifies, in an address bar 807 of the browser, a network address, ADDRESS1 (809), associated with the desired content, as shown in FIG. 8. The browser (of user device 160-A) provides the address to network manager 135. Network manager 135 forwards the address to content manager 140, in response, content server 510 (of content manager 140) retrieves the specified content from the appropriate content server 170. Content manager 140 then causes user device 160-A to display the content (in the form of a web page). In the illustrative embodiment, the user accesses a web page associated with a history website, as shown in FIG. 9A. Web page 900 comprises a plurality of articles related to various historical topics, including a first article 902 related to “George Washington Biography,” a second article 904 related to “Ancient Chinese Terra-Cotta Soldiers Discovered,” and a third article 906 related to “Trade in Pre-Columbian. America.”

While the user is accessing web page 900, ratings module 410 (of ratings service 130) causes use device 160-A to display a “Rate Content” option 911 at a selected location on web page 900. In the illustrative embodiment, Rate Content button 911 is displayed within address bar 807, in the upper-right corner of web page 900.

While the user is visiting web page 800, the user selects Rate Content option 911. In response, ratings module 410 (of ratings service 130) causes user device 160-A to display a query box 933 on web page 900, as shown in FIG. 9B. Query box 933 asks the user if he or she wishes to rate the content of web page 900. The user may select “YES’ button 941 if the user wishes to rate the content or “NO” button 942 if the user does not wish to rate the content,

In the illustrative embodiment, the user selects “YES” button 941, in response, ratings module 410 (of ratings service 130) causes user device 160-A to display a ratings box 955 on web page 900, as shown in FIG. 9C. Ratings box 955 includes a learn field 966, an inspire field 967, a fun field 968, and an ethics field 969, allowing the user rate the content of web page 900 with respect to each of these respective attributes or parameters, in the illustrative embodiment, the user of user device 160-A deems the web page to be useful for learning and assigns a rating of “8” for the learn attribute (field 966). The user believes that the web page is moderately inspirational and thus assigns a “6” for the inspire attribute (field 967). The user believes that the web page is not very fun and thus assigns a “3” to the fun attribute (field 968). The user feels that the web page encourages ethical thinking and thus assigns a “6” to the ethics attribute (field 969). When the user wishes, he or she may then submit his or her ratings by selecting a “SUBMIT” button 970 within box 955.

Ratings module 410 may request additional ratings relating to other topics. Referring to FIG. 9D, for example, ratings module 410 causes user device 160-A to display a worldview factors box 975 which invites the user to rate the content of web page 900 with respect to the content's relationship to one or more topics, issues, etc. In the illustrative embodiment, box 975 includes a religion question 984 asking whether the content in question is oriented to any particular religion, and a politics question 986 asking whether the content is oriented to any particular political viewpoint.

Referring to FIG. 9E, ratings module 410 causes user device 160-A to display a second ratings box 979 asking the user to enter, in a field 981, an age requirement for the content, and, in field 983, to indicate whether or not the content contains violence.

While in the illustrative embodiment described herein, ratings are obtained with respect to certain attributes and questions, these examples are not to be construed as limiting. In other embodiments, ratings and answers may be obtained from a user concerning any content attribute and with respect to any type of question, on any topic.

After the user provides ratings and/or answers with respect to various attributes, parameters and/or questions, ratings module 410 receives the user's ratings and answers and stores the ratings and answers in a user ratings database 448, which is maintained in storage 420 (shown in FIG. 4). User rating database 448 thus records the ratings information submitted by various users of communication system 100 as the users view and rate various items of content.

Suppose that the user of user device 160-A now visits a videogame website associated with a second address ADDRESS2. As shown in FIG. 10, when the user accesses the videogame website, content manager 140 retrieves the content associated with ADDRESS2 (808), which is displayed in address bar 807, and causes laser device 160-A to display a web page such as that shown in FIG. 10. Web page 1000 is associated with a violent videogame called “Blood & Guts Videogame.” In a manner similar to that described above, while the user is visiting web page 1000, ratings service 130 causes Rate Content button 911 to appear in address bar 807. Supposing that the user selects Rate Content button 911, ratings service 130 causes user device 160-A to display ratings box 955 on the web page, as shown in FIG. 10. Now the user indicates enters a “0” for the learn parameter (field 966), a “0” for the inspire parameter (field 967), a “5” for the fun parameter (field 968), and a “0” for the ethics parameter (field 969), and submits the ratings by pressing “SUBMIT” button 970. Ratings module 410 receives the user' s ratings and stores the ratings information in user ratings database 448.

Ratings module 410 accesses the ratings received from users, as recorded in user ratings database 448, and generates, for one or more items of content available, via network 105, a combined rating representing a combination of the various ratings received. For example, ratings module 410 may average user ratings received for a particular item of content, where appropriate, to generate a set of averaged user ratings for the content. Other methods may be used to combine user ratings. Combined ratings are stored in combined content ratings database 450 (as shown in FIG. 4).

FIG. 11 shows combined content ratings database 450 in accordance with an embodiment. Database 450 comprises a content identifier column 1111 holding an identifier of particular content available via network 105. For example, content identifier column 1111 may hold a world wide web address associated with a web page, or another type of address. Database 450 also includes a learn column 1113 indicating a learn rating associated with the content identified in column 1111. For example, learn column 1113 may hold a running average of learn ratings received from users with respect to the content. Database 450 includes an inspire column 1115 indicating an inspire rating associated with the content identified in column 1111. For example, inspire column 1115 may hold a running average of inspire ratings received from users with respect to the content. Database 450 includes a fun column 1117 indicating a fun rating associated with the content identified in column 1111. For example, fun column 1117 ma hold a running average of fun ratings received from users with respect to the content. Database 450 includes an ethics column 1119 indicating an ethics rating associated with the content identified in column 1111. For example, ethics column 1119 may hold a running average of ethics ratings received from users with respect to the content. Database 450 also includes a religion column 1121 indicating a degree to which the content is associated with any particular religion. Column 1121 may hold one or more percentage values indicating what percentage of respondents indicated that the content is oriented to a particular religion. Database 450 also includes a politics column 1123 indicating a percentage of respondents who indicated that the content is associated with as particular political viewpoint. Database 450 also includes an age column 1125 reflecting an average of user ratings relating to age appropriateness, and a violence column 1127 reflecting a percentage of respondents who indicated that the content contains violence.

Database 450 may include other columns containing ratings related to any other type of issue that may be of interest to some or all users. For example, in the illustrative embodiment of FIG. 11, database 450 includes an evolution column 1129 indicating a percentage of respondents who indicated that the content is oriented toward evolution.

Thus, referring to record 1146, the content available at the history website address has obtained an average 7.8 rating for the learn parameter, an average 6.6 rating for the inspire parameter, an average 2.4 rating for the fun parameter, and an average 7.1 rating for the ethics parameter. Zero percent (0%) of respondents indicated that die content is oriented to any religion. Eighteen percent (18%) of respondents indicated that the content is oriented to a politically liberal viewpoint. Users indicated that the content is appropriate for all ages. Zero percent (0%) of respondents indicated that the content contains violence, Zero percent (0%) of respondents indicated that the content is related to evolution.

Referring now to record 1147, the content available at the Blood & Guts Videogame website address has obtained an average 1.3 rating for the leant parameter, an average 2.5 rating for the inspire parameter, an average 7.5 rating for the fun parameter, and an average 0.3 rating for the ethics parameter. Zero percent (0%) of respondents indicated that the content is oriented to any religion. Zero percent (0%) of respondents indicated that the content is oriented to a political viewpoint. Users indicated that the content is appropriate for persons older than 17 years of age. Ninety-seven percent (97%) of respondents indicated that the content contains violence. Zero percent (0%) of respondents indicated that the content is related to evolution.

In accordance with another embodiment, each user of communication system 100 has an associated trust score indicating a level of trust that the user has earned from other users (and/or from network administrators). For example, a trust score may be a value from zero to ten, in the illustrative embodiment, a newly-registered user has a trust score of zero; the user's trust score may increase based on a variety of factors including the user's role and actions within communication system 100, the user's demonstrated knowledge of certain topics, etc. For example, in one embodiment, a user's trust score may increase after being registered for a predetermined period of time. In another embodiment, a user may increase his or her trust score by rating content; for example, the user's trust score increases by a predetermined amount for every ten ratings the user generates. In another embodiment, a user's role in the community may influence his or her trust score. For example, a user who is a religious leader may earn a higher trust score.

In the illustrative embodiment of FIG. 2, controller 210 (of network manager 135) stores user trust scores in user trust score database 279. FIG. 12 shows user trust score database 279 in accordance with an embodiment. User trust score database 279 comprises a column 1202 holding identifiers of various users and a column 1204 holding a trust score for each respective user. Thus, record 1221 indicates that the user identified as User-1 has a trust score of 7.3; record 1222 indicates that the user identified as User-2 has a trust score of 0.8; and record 1223 indicates that the user identified as User-3 has a trust score of 3.5. As a user's trust score increases or decreases, user trust score database 279 is updated to reflect the change.

In accordance with another embodiment, ratings module 410 of ratings service 130) may determine a combined rating for a particular item of content based on user ratings and on user trust scores. For example, ratings module 410 may determine a weighted average rating for a particular attribute of the item of content. Thus, for example, in order to determine a combined learn rating for a particular item of content, ratings module 410 may examine the learn ratings submitted by users for the content, and, for each respective user, weight the user's learn rating based on the user's trust score to generate a weighted learn rating. Ratings module 410 may then calculate a weighted average learn rating for the content based on all the weighted learn ratings computed in this manner. In other embodiments, the combined ratings in combined content ratings database 450 may be determined in a different manner.

FIG. 13 shows combined content ratings database 450 in accordance with an embodiment, in winch combined rating values are determined based on weighted average values. Database 450 comprises a content identifier column 1311 holding an identifier of particular content available via network. 105. Database 450 also includes a weighted average, learn rating column. 1313, a weighted average inspire rating column 1315, a weighted average fun rating column 1317, a weighted average ethics rating column 1319, a weighted percentage religion rating, column 1321, a weighted percentage politics rating column 1323, a weighted average age rating column 1325, a weighted percentage violence rating column 1327, and a weighted percentage evolution rating column 1329. Thus, for example, record 1346 indicates that the content identified as history website has a weighted average learn rating of 8.4, a weighted average inspire rating of 6.8, a weighted average fun rating of 2.7, a weighted average ethics rating of 6.7, a weighted percentage religion rating of two percent (2%), a weighted percentage politics rating of 14% Liberal, a weighted average age rating of ALL, a weighted percentage violence rating of Zero percent (0%), and a weighted percentage evolution rating of zero percent (0%).

In accordance with an embodiment, information relating to a user's personal values, philosophy, preferences, beliefs, priorities, opinions, etc., is obtained, stored, and utilized subsequently to filter content for the user.

Referring again to the illustrative embodiment of FIG. 1, suppose now that a new user employing user device 160-B registers and logs into the website maintained by network manager 135, for example, by entering a username and password on user login page 700 shown in FIG. 7). After logging in, user worldview service 120 detects that the user is a new user and prompts the user to enter information concerning the user's personal values, philosophy, preferences, beliefs, priorities, opinions. etc. For example, user polling module 310 (of worldview service 120) may cause user device 160-B to display a filtering criteria page such as that shown in FIG. 14. Page 1400 comprises a plurality of parameter fields allowing the user to enter information defining his or her values, beliefs, priorities, etc.

Suppose that the user of user device 160-B has several children and wishes to establish filtering criteria for content accessed from user device 160-B, to ensure that the children do not access any content that does not conform to the user's priorities, values, etc. Referring to FIG. 14, fields 1411, 1413, 1415, and 1417 specify four filtering parameters LEARN, INSPIRE, FUN, and ETHICS, and allow the user to assign, for each respective parameter, a criterion that any content must satisfy in order to be accessed from user device 160-B. Thus, the user of user device 160-B, desiring content that facilitates learning, and content that inspires, assigns a minimum value of “7” for LEARN and minimum value of “6” for IN Thus content must have a minimum LEARN rating of “7” and a minimum INSPIRE rating of “6” to be accessed by user device 160-B. Not wishing to block academic content that may have a low FUN rating, the user assigns a relatively low minimum value of “2” to FUN. Thus, any content having a FUN rating of 2 or more may be accessed by user device 160-B. Concerned about the children viewing content that may encourage unethical behavior, the user assigns a minimum value of “6” to ETHICS.

Page 1400 also includes an age field 1421 and a violence field 1423. The user, wishing to block any content that is not specifically designed for children, and also wishing to block all violent content, enters “<16” in field 1421 and “NO” in field 1423.

Page 1400 also provides the user an opportunity to describe his or her affinities, views, opinions, etc. with respect to one or more topics. Page 1400 may prompt the user to enter answers to any type of question on any topic, in the illustrative embodiment, page 1400 presents a religion question 1435, where the user may indicate a religion, and a politics question 1445, where the user may indicate a political viewpoint. Other questions not shown in FIG. 14, related to other topics not shown in FIG. 14, may be presented.

User worldview service 120 receives the values submitted by the user to various parameters presented on web page 1400, and the user's answers to various question presented on web page 1400, and records the user information in a user worldview database 360, which is stored in storage 330, as shown in FIG. 3. FIG. 15 shows user worldview database 350 in accordance with an embodiment. User worldview database 360 comprises a user device identifier column 1511 holding an identifier of a user device. Database 360 also includes a learn column 1513, a inspire column 1515, a fun column 1517, and an ethics column 1519, holding values assigned by a user to the learn, inspire, fun, and ethics parameters, respectively. Database 360 also comprises a religion column 1521 indicating the user's answer (if any concerning religion, a politics column 1523 indicating the user's answer (if any concerning politics, an age column 1525 indicating any age limit the user specified for content, and a violence column 1527 specifying any restriction the user entered regarding violent content. Database 360 may also include additional columns indicating additional restrictions a user may specify concerning other topics. For example, in the illustrative embodiment, database 360 includes an evolution column 1529 indicating whether or not the user wishes to allow or block content relating to evolution.

Thus, records 1541, 1542, and 1543 contain criteria associated with user devices 160-A, 160-B, and 160-C, respectively. Referring in particular to record 1542, the user of user device. 160-B indicated “7” fix’ learn, “6” for inspire, “2” for bin, and “6” for ethics (columns 1513, 1515, 1517, 1519). The user did not provide information for either religion or politics (columns 1521, 1523). Referring to columns 1525 and 1527, the user specified that only content directed to children under age 16 is to be permitted, and that no violent content is allowed. Referring to column 1529, the user indicated that content related to evolution is permitted.

Referring now to record 1543, the user of user device 160-C indicated “5” for learn, “4” for inspire, “7” for fun, and “6” for ethics (columns 1513, 1515, 1517, 1519). The user did not provide information for religion (column 1521) but indicated a “conservative” political viewpoint (column 1523). Referring to columns 1525 and 1527, the user indicated that content for all ages is to be permitted, and that violent content is allowed. Referring to column 1529, the user indicated that content related to evolution is prohibited.

In accordance with an embodiment, content is filtered used on the combined ratings stored in combined content ratings database 450 and on user parameters associated with a particular user. FIG. 16 is a flowchart of a method of filtering content in accordance with an embodiment.

At step 1610, a plurality of ratings associated with content accessible at an internet address is received, from a plurality of users, wherein each of the ratings corresponds to one of a plurality of content attributes. As described above, ratings for various items of content accessible via network 105 are received from various users and stored in user ratings database 448.

At step 1620, a combined set of ratings is generated for the content based on the plurality of ratings, the combined set of ratings comprising, for each of the plurality of content attributes, a combined rating value. For each item of content, a combined set of ratings is generated, as described above, and stored in combined content ratings database 450. Thus, referring to FIG. 11 and/or FIG. 13, a combined set of ratings is generated and stored for the history website (record 1146, for example) and for the Blood & Guts Videogame website (record 1147, for example). The combined ratings may be weighted averages based at least in part on user trust scores, as shown in FIG. 13.

At step 1630, a plurality of criteria are received from a user device, wherein each criterion corresponds to a respective one among the plurality of content attributes. As described above, a user, such as the user of user device 160-B, may enter a set of parameters defining his or her preferences, opinions, worldview, etc. Such parameters are stored in user worldview database 360 (shown in FIG. 3).

At step 1640, a request to access the content is received from the user device. Suppose now that a person employing user device 160-B (for example, a teenage son of the original user) attempts to access Blood & Guts videogame website, in the illustrative embodiment, the request to access the website is transmitted to content manager 140.

At step 1650, the combined set of ratings is compared to the plurality of criteria received from the user device. Filtering module 140 examines the request and identifies the source thereof as user device 160-B. Filtering module 140 therefore requests from user worldview service 120 the filtering parameters associated with user device 160-B. User worldview service 120 accesses use worldview database 360 and provides the filtering parameters associated with user device 160-B. Filtering module 140 stores the filtering parameters for user device 160-B in a user worldview file 570 in storage 510 of content manager 140). Content manager 140 also requests from ratings service 130 the combined content ratings associated with the Blood & Guts Videogame website. In response, ratings service accesses combined content ratings database 450, retrieves the combined ratings associated with the Blood &. Guts Videogame website, and provides the combined ratings to content manager 140. Filtering module 520 stores the combined ratings in a content ratings file 580 within storage 530. Filtering module 520 now compares the combined content ratings with the user filtering parameters.

Filtering module 520 examines the filtering parameters associated with user device 160-B (shown in record 1542 of FIG. 15) and the combined ratings associated with the Blood Guts Videogame website (shown in record 1347 of FIG. 13, for example). Filtering module 520 determines that the Blood & Guts Videogame website has a weighted percentage violence rating of 99%, which conflicts with the user filtering criterion for violence (“NO”). Also, the combined ratings of the Blood & Guts Videogame website conflict with several of the filtering requirements of user device 160-B, including the requirement for the learn attribute (0.6 vs. 7) and the inspire attribute (1.5 vs. 6).

At step 1660, the user device is allowed to access the content if the combined set of ratings does not conflict with the plurality of criteria. At step 1670, the user device is prevented from accessing the content if the combined set of ratings conflicts with the plurality of criteria. Because the Blood & Guts Videogame website's combined ratings conflict with the user filtering criteria, user device 160-B is prevented from accessing the Blood & Guts Videogame website. Filtering module 520 may cause user device 160-B to display a message informing the user that he or she is not permitted to access the requested content. In the illustrative embodiment, user device 160-B displays a message 1725 stating “This Content Has Been Blocked,” as shown in FIG. 17.

In accordance with another embodiment, search results generated in response to a search request received from a user are prioritized and presented in an order determined based on the behavior of, and ratings provided by, users having a worldview similar to that of the user. FIGS. 18A-18C comprise a flowchart of a method of prioritizing search results in accordance with an embodiment.

Suppose, for example, that a user of user device 160-C now wishes to perform a search related to a particular topic of interest. Accordingly, the user logs in and, when presented with menu page 800 (Shown in FIG. 8), selects Search button 810. Network manager 135 transmits the user's selection to search service 150. Search engine 610 now causes user device 160-C to display a search page such as that shown in FIG. 19. Search page 1900 comprises a keyword field 1903 and a search button 1906. The user enters a keyword, “Keyword-1,” in field 1903, and selects search button 1906.

At step 1805, a plurality of search results are obtained based on a request from a first user of a communication network, wherein each search result is associated with content accessible via the communication network. Search engine 610 performs a search of content stored on content servers 170 based on the keyword provided by the user. In one embodiment, search engine may perform a search using known methods and/or search functionality provided by one or more publicly available search engines, in another embodiment, search engine 610 may perform a search using proprietary search techniques. Search engine 610 generates a plurality of search results 2000, as shown in FIG. 20. Search results 2000 include Result1 (2001), Result2 (2002), Result3 (2003), Result4 (2004), Result5 (2005), Result6 (2006), etc. Search results 2000 are stored in storage 630 (of search service 150), as shown in FIG. 6.

At step 1810, a first plurality of criteria associated with the first user are obtained, wherein each of the first plurality of criteria corresponds to a respective one among a plurality of content attributes. Content prioritization module 620 (of search service 150) requests from user worldview service 120 the user filtering criteria associated with user device 160-C. In response, user worldview service 120 accesses user worldview database 360, retrieves the filtering criteria associated with user device 160-C (stored in record 1543 of database 360), and transmits the criteria to search service 150. Content prioritization module 620 stores the user-provided filtering criteria in a user worldview file 670 within storage 630 (of search service 150).

In the illustrative embodiment, content prioritization module 620 applies the user-provided filtering criteria to search results 2000 and eliminates any search results that conflict with the filtering criteria. For example, suppose that the filtering criteria associated with user device 160-C indicate that violent content is prohibited. Therefore, content prioritization module 620 removes any content that contains violence from search results 2000. Content prioritization module 620 also removes any content that does not satisfy the filtering criteria associated with user device 160-A. Referring to record 1543, content that does not have a learn rating of 5 or above is removed; content that does not have an inspire rating of 4 or above is removed, etc. In the illustrative embodiment. Result (2003) does not satisfy the filtering criteria associated with user device 160-C and is removed, as shown in FIG. 21.

At step 1815, a plurality of second users of the communication network are identified, wherein each second user has a second plurality of criteria that has a predetermined degree of similarity to the first plurality of criteria. Content prioritization module 620 now requests from user worldview service 120 a list of users who have a worldview that shares a predetermined degree of similarity to the worldview of the user of user device 160-C. User worldview service 120, in response, accesses user worldview database 360 and examines the filtering and worldview parameters associated with user device 160-C. User worldview service 120 then searches user worldview database 360 to identify other users whose filtering and worldview parameters share a predetermined degree of similarity. Similarity of worldviews may be determined using any suitable method. For example,in one embodiment, two users are determined to have similar worldviews if each of their learn, inspire, fun, and ethics scores differ by no more than two points. In another embodiment, two worldviews are determined to be similar if they indicate the same religious and/or political viewpoint. User worldview service 120 provides the list of similar-minded users to search service 150.

At step 1820, for each second user among the plurality of second users, a trust score earned by the respective second user based on activities conducted within the communication network is determined. Content prioritization module 620 of search service 150) receives the list of similar-minded users, and requests from network manager 135 the trust scores for the similar-minded users on the list provided by user worldview service 120. Network manager 135 retrieves the trust scores from user trust score database 279 and provides the trust scores to content prioritization module 620. Content prioritization module 620 stores the list of similar users and their trust scores in a similar users trust scores file such as that shown in FIG. 22. Similar user trust score file 680 comprises a column 2202 which includes identifiers of various users having similar worldviews. Column 2204 indicates a trust score for each respective user listed in column 2202. Thus, record 2215 indicates that the user identified as User-1832 has a trust score of 7.3; record 2216 indicates that the user identified as User-7508 has a trust score of 1.2; etc.

Referring to block 1825, for each search result among the plurality of search results, a series of first operations is performed. The series of first operations is described by blocks 1830 through 1860. Thus, for example, for Result1 (2001), content prioritization module 620 performs the steps outlined, in blocks 1830 through 1860.

Referring to block 1830, for each second user among the plurality of second users, a series of second operations is performed. The series of second operations is described by blocks 1835 through 1855. Content prioritization module 620 performs the following steps with respect to each similar user listed in similar user trust scores file 680. Referring to FIG. 22, content prioritization module 620 may begin with User-1832.

At step 1835, a frequency value indicating how often the respective second user views the respective, search result is determined. Thus, content prioritization module 620 requests from network manager 135 information indicating how frequently User-1832 Views the content associated with Result1 (2001). In the illustrative embodiment, network manager 135 provides information indicating that User-1832 has visited the content associated with Result1 (2001) six (6) times. The frequency value may be a value indicating a number indicating how many times the user has viewed the content over all time, how many times the user views the content per month, per year, etc. Content prioritization module 620 stores the information in a similar users behavior file 681 such as that shown in FIG. 23. Similar users behavior file 681, includes a column 2300 containing identifiers of various similar users. Similar users behavior file 681 also comprises respective columns corresponding to respective search results. Thus file 681 includes column 2301 corresponding to Result1 (2001), column 2303 corresponding to Result2 (2002), column 2305 corresponding to Result3 (2003), etc. Frequency values indicating how frequently each user visits each respective item of content is stored appropriately. Thus, referring to FIG. 23, record 2322 contains frequency values for User-1832; the frequency value indicating that User-1832 has visited the content associated with Result1 (2001) six (6) times is stored in cell 2365. Other frequency values are stored as they are received. Similar users behavior file 681 is stored in storage 530, as shown in FIG. 6.

At step 1840, at least one rating value indicating a rating produced by the respective second user with respect to an attribute of the content associated with the respective search result is determined. Content prioritization module 620 requests from ratings service 130 information indicating any ratings that User-1832 submitted with respect to the content associated with Result1 (2001). Ratings service 130 accesses user ratings database 448 and provides the requested information. Content prioritization module 620 stores the user's ratings information in a similar users ratings file such as that shown in FIG. 24. Similar users ratings file 582 contains ratings by similar users with respect to the content associated with Result1 (2001). File 682 comprises a column 2401 containing identifiers of various users. Similar users ratings file 682 comprises columns corresponding to various content attributes for which ratings ma be provided. Thus, file 682 includes a learn rating column 2402, an inspire rating column 2404, a fun rating column 2406. etc. Referring to FIG. 24, ratings provided by User-1832 for the content associated with Result1 (2001) is stored in record 2421. For example, User-1832 provided a learn rating of 6, an inspire rating of 3, a fun rating of 5, etc., for the content. Ratings of the content associated with Result1 (2001) provided by other similar users are stored in file 682 as they are receive(Similar users ratings file 582 is stored in storage 630, as shown in FIG. 6.

In the illustrative embodiment, a separate similar user ratings file may be generated and stored for each search result.

At step 1845, the frequency value is weighted based on the trust score of the respective second user, generating a weighted frequency value. In the illustrative embodiment, content prioritization module 620 examines similar users trust scores file 680 and updates the frequency value of User-1832 stored in similar Users behavior file 681 based on the trust score of User-1832, generating a weighted frequency value.

At step 1850, the rating value is weighted based on the trust score of the respective second user, generating a weighted rating value. Content prioritization module 620 similarly updates the ratings of User-1832 stored in similar users ratings file 682 based on the trust score of User-1832, generating one or more weighted rating values.

Referring to block 1855, if other second users remain to be examined, the routine returns to block 1830. Otherwise, the routine proceeds to block 1860.

Referring to FIG. 22, in the illustrative embodiment, content prioritization module 620 may identify User-7508. User-8556, etc., as additional similar users to examine, and return to block 1830. After all the listed similar users are examined, content prioritization proceeds to block 1860.

At step 1860, at least one combined weighted frequency value, and a set of combined weighted rating values, are generated for each respective search result among the plurality of search results. Thus, for the respective search result, content prioritization module 620 combines the weighted frequency values that are produced in the manner described above by, for example, averaging the weighted frequency values. In one embodiment, a single combined weighted average frequency value is computed for each search result. Similarly, for each search result, content prioritization module 620 combines the weighted rating values that are produced in the manner described above by, for example, averaging the weighted rating values for each content attribute to produce, for each content attribute, a combined weighted average rating.

Referring to block 1865, if another search result remains to be analyzed, the routine returns to block 1825. Otherwise, the routine proceeds to step 1870.

Referring to FIG. 21, content prioritization module 620 identifies Result2 (2002), Result4 (2004), etc., as subsequent search results to examine, and returns to block 1825. When all of the search results have been analyzed, content prioritization module 620 proceeds to step 1870.

At step 1870, respective priority values are determined for the plurality of search results, based on the combined weighted frequency value(s), the sets of combined weighted rating values, and the first plurality of criteria. Content prioritization module 620 generates a ranking of the search results based on the combined weighted frequency values, the sets of combined weighted rating values, and the user's filtering criteria. For example, in one embodiment, search results whose weighted average rating values demonstrate higher ratings in content attributes that the user ranked of high importance are ranked higher. In another embodiment, a search result may be ranked higher if its weighted average frequency value(s) show that its content is more frequently viewed by similar users.

Content prioritization module 620 re-orders search results 2000 in accordance with the ranking generated at step 1870. FIG. 25 shows search results 2000 reordered in accordance with an embodiment. Search results 2.000 now are ordered as follows: Result5 (2005), Result4 (2004), Result18 (2018), Result1 (2001), Result10 (2010), etc.

At step 1875, the plurality of search results are provided to the first user arranged in an order determined based on the priority values. In the illustrative embodiment, search engine 610 causes user device 160-C to display the reordered search results to the user. For example, user device 160-C may display a search results page such as that shown in FIG. 26. Starch results page 2600 displays Result5 (2005), Result4 (2004), Result18 (2018), Result1 (2001), Result10 (2010), etc., in accordance with the ranking determined in the manner described herein.

In various embodiments, the method steps described herein, including the method steps described in FIGS. 16 and/or 18A-18C, may be performed. In an order different from the particular order described or shown. In other embodiments, other steps may be provided, or steps may be eliminated, front the described methods.

Systems, apparatus, and methods described, herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located, remotely from the server computer and interact via a network. The client-server relationship may be defined and controlled by computer programs running on the respective client and server computers.

Systems, apparatus, and methods described herein may be used within a network based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIGS. 16 and/or 18A-1 8C, may be implemented using one or more computer programs that are executable by such a processor. A computer program is a set of computer program instructions that can be used, directly or indirectly, in a combiner to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of an exemplary computer that may be used to implement systems, apparatus and methods described herein is illustrated in FIG. 27. Computer 2700 includes a processor 2701 operatively coupled to a data storage device 2702 and a memory 2703. Processor 2701 controls the overall operation of computer 2700 by executing computer program instructions that define such operations. The computer program instructions may be stored in data storage device 2702, or other computer readable medium, and loaded into memory 2703 when execution of the computer program instructions is desired. Thus, the method steps of FIGS. 16 and/or 18A-18C can be defined by the computer program instructions stored in memory 2703 and/or data storage device 2702 and controlled by the processor 2701 executing the computer program instructions. For example, the computer program instructions can be implemented as computer executable code programmed by one skilled in the art to perform an algorithm defined by the method steps of FIGS. 16 and/or 18A-18C. Accordingly, by executing the computer program instructions, the processor 2701 executes an algorithm defined by the method steps of FIGS. 16 and/or 18A-18C. Computer 2700 also includes one or more network interfaces 2704 for communicating with other devices via a network. Computer 2700 also includes one or more input/output devices 2705 that enable user interaction with computer 2700 (e.g., display, keyboard, mouse, speakers, buttons, etc.).

Processor 2701 may include both general and special purpose microprocessors, and may be the sole processor or one of multiple processors of computer 2700. Processor 2701 may include one or more central processing units (CPUs), for example. Processor 2701, storage device 2702, and/or memory 2703 may include, be supplemented by, or incorporated in, one or more application-specific integrated circuits (ASICs) and/or one or more field programmable gate arrays (FPGAs).

Data storage device 2702 and memory 2703 each include a tangible non-transitory computer readable storage medium. Data storage device 2702, and memory 2703, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or oilier non-volatile solid state storage devices.

Input/output devices 2705 may include peripherals, such as a printer, scanner, display screen, etc. For example, input/output devices 2705 may include a display device such as a cathode ray tube (CRT) or liquid crystal display (LCD) monitor for displaying information to the user, a keyboard, and a pointing device such as s mouse or a trackball by which the user can provide input to computer 2700.

Any or all of the systems and apparatus discussed herein, including network manager 135, user worldview service 120, ratings service 130, content manager 140, search service 150, and components thereof, including, for example, controller 210, user registration & login module 220, storage 230, etc., may be implemented using a computer such as computer 2700.

One skilled in the art will recognize that an implementation of an actual computer or computer system may have other structures and may contain other components as well, and that FIG. 27 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method of filtering content, the method comprising:
receiving, from a plurality of users, a plurality of ratings associated with content accessible at a network address, wherein each of the ratings corresponds to one of a plurality of content attributes;
generating a combined set of ratings for the content based on the plurality of ratings, the combined set of ratings comprising, for each of the plurality of content attributes, a combined rating value;
receiving, from a user device, a plurality of criteria, each criterion corresponding to a respective one among a plurality of content attributes;
receiving from the user device a request to access the content;
comparing the combined set of ratings to the plurality of criteria received from the use device;
allowing the user device to access the content if the combined set of ratings does not conflict with the plurality of criteria; and
preventing the user device from accessing the content if the combined set of ratings conflicts with the plurality of criteria.

2. The method of claim 1, further comprising:
causing a second user device employed by one of the plurality of users to display a rate content option;
receiving a selection of the rate content option; and
in response to the selection, prompting the one user to provide one or more ratings associated with the content.

3. The method of claim 1, wherein generating the combined set of ratings further comprises:
determining, for each of the plurality of users, a respective trust score;
adjusting the plurality of ratings based on one or more trust scores, generating a weighted set of ratings; and
generating for each of the plurality of content attributes, a weighted average rating based on the weighted set of ratings.

4. The method of claim 3, wherein adjusting the plurality of ratings further comprises increasing a rating value provided by a particular user when a trust score of the particular user is determined to be above a predetermined value.

5. The method of claim 1, wherein the plurality of content attributes comprise a learn attribute, an inspire attribute, a fun attribute, and an ethics attribute.

6. The method of claim 5, wherein the plurality of content attributes further comprises one of a religion attribute and a political viewpoint attribute.

7. A method of providing information, the method comprising:
obtaining a plurality of search results based on a request from a first user of a communication network, each search result being associated with content accessible via the communication network;
obtaining a first plurality of criteria associated with the first user, each of the first plurality of criteria corresponding to a respective one among a plurality of content attributes;
identifying a plurality of second users of the communication network, each second user having a second plurality of criteria that has a predetermined degree of similarity to the first plurality of criteria;
determining, for each second user among the plurality of second users, a trust score earned by the respective second user based on activities conducted within the communication network;
for each search result among the plurality of search results, performing a series of first operations comprising:
for each second user among the plurality of second users, performing a series of second operations comprising:
determining a frequency value indicating how often the respective second user views the respective search result;
determining at least one rating value indicating a rating produced by the respective second user with respect to an attribute of the content associated with the respective search result;
weighting the frequency value based on the trust score of the respective second user, generating a weighted frequency value;
weighting the rating value based on the trust score of the respective second user, generating a weighted rating value,
generating at least one combined weighted frequency value and a set of combined weighted rating values for each respective search result among the plurality of search results;
determining respective priority values for the plurality of search results, used on the at least one combined weighted frequency value, the set of combined weighted rating values, and the first plurality of criteria; and
providing the plurality of search results to the first user arranged in an order determined based on the priority values.

8. The method of claim 7, further comprising:
determining that a second user has a second plurality of criteria that has a predetermined degree of similarity to the first plurality of criteria when a first predetermined number of the first plurality of criteria differ from corresponding ones of the second plurality of criteria by less than a second predetermined number.

9. The method of claim 7, wherein the plurality of content attributes comprise a learn attribute, an inspire attribute, a fun attribute, and an ethics attribute.

10. The method of claim 9, wherein the plurality of content attributes further comprises one of a religion attribute and a political viewpoint attribute.

11. The method of chain further comprising:
generating the at least one combined weighted frequency value by averaging the weighted frequency values; and
generating the set of combined weighted values averaging the weighted rating values.

12. A system comprising:
a storage adapted to store one or more ratings;
a processor adapted to:
receive, from a plurality of users, a plurality of ratings associated with content accessible at a network address, wherein each of the ratings corresponds to one of a plurality of content attributes;
generate a combined set of ratings for the content based on the plurality of ratings, the combined set of ratings comprising, for each of the plurality of content attributes, a combined rating value;
receive, from a user device, a plurality of criteria, each criterion corresponding to a respective one among a plurality of content attributes;
receive from the user device a request to access the content;
compare the combined set of rating to the plurality of criteria received from the user device;
allow the user device to access the content the combined set of ratings does not conflict with the plurality of criteria; and
prevent the user device from accessing the content if the combined set of ratings conflicts with the plurality of criteria.

13. The system of claim 12, wherein the processor is further adapted to:
cause a second user device employed by one of the plurality of users to display a rate content option;
receive a selection of the rate content option; and
in response to the selection, prompt the one user to provide one or more ratings associated with the content.

14. The system of claim 12, wherein the processor is further adapted to:
determine, for each of the plurality of users, a respective trust score;
adjust the plurality of ratings based on one or more trust scores, generating a weighted set of ratings; and
generate, for each of the plurality of content attributes, a weighted average rating based on the weighted set of ratings.

15. The system of claim 14, wherein the processor is further adapted to:
increase a rating value provided by a particular user when a trust score of the particular user is determined to be above a predetermined value.

16. The system of claim 12, wherein the plurality of content tributes comprise a learn attribute, an inspire attribute, a fun attribute, and an ethics attribute.

17. The system of claim 16, wherein the plurality of content attributes further comprises one of a religion attribute, and a political viewpoint attribute.
